(19) United States
(12) Patent Application Publication
(10) Pub. No.: US 2009/0229141 A1
(43) Pub. Date: Sep. 17, 2009

(54) Exhaust air dryer with air circulation and method for its operation

(75) Inventors: Thomas Nawrot, Berlin (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/381,486

(22) Filed: Mar. 12, 2009

(30) Foreign Application Priority Data
Mar. 14, 2008 (DE) 10 2008 014 305.7

(51) Int. Cl. F26B 3/02; D06F 58/04; F26B 21/00

(52) U.S. Cl. 34/467; 34/134; 34/82

(57) ABSTRACT

An exhaust air dryer with a drum for drying damp laundry with warm process air, a heating device for the process air into which leads a first process air channel upstream of the drum, into which a supply air channel and a first end of a circulating air channel discharge, a second process air channel downstream of the drum, into which an exhaust air channel and a second end of the circulating air channel discharge, and a fan including an impeller with a blade configuration, the impeller having blades which are straight and/or curved backwards in the direction of movement toward the drum.

### BACKGROUND OF THE INVENTION

The invention relates to an exhaust air dryer with circulating air section and a method for its operation. The invention relates in particular to such an exhaust air dryer, having a fan with a specially shaped impeller.

In a dryer, in particular a laundry tumble dryer, laundry in a generally rotating drum is dried in that a heated stream of air is passed through the drum and thus through the laundry, which is in a position to remove moisture from the damp laundry, by means of which the laundry is gradually dried.

The supplied stream of air (“process air stream”) is heated in a feed line (supply air channel or herein “first process air channel”) upstream of the drum (“laundry drum”) by means of a heating device and after its passage through laundry in the drum either diverted to the outside (exhaust air dryer) or directed to a heat exchanger, in which the stream of air is cooled, and the moisture separates out as condensate. A fan (process air fan) is generally used to convey the stream of air, said fan being embodied in particular as a radial fan and having an impeller (also known as a “drum impeller” or “radial-fan wheel”).

Generally, an impeller of a radial fan employed in a dryer has blades which are curved forwards (that is in the direction of movement) for an optimal air volume flow. In the case of a dryer in which the radial fan is coupled with a drive motor for the drum, where the drum is driven in a reversing manner, that is with an alternating direction of movement, an impeller with straight blades and symmetrical spiral geometry is frequently used, in order to realize air volume flows of the same magnitude for both directions of rotation. However a fan with blades which are curved forwards (that is in direction of movement) has a tendency to become easily soiled. The tendency toward soiling is particularly marked when the fan is employed to convey process air containing fluff. This is the case with an exhaust air dryer with a circulating air section or a dryer exclusively employing circulating air. An exclusively circulating air dryer generally, however, takes the form of a condensation dryer, in which condensed airborne moisture also contributes to the deposition of fluff.

DE 34 19 743 A1 discloses a dryer for laundry, in which an electrical heating unit equipped with a supply air connection is attached in the upper section of the dryer's rear wall, while an exhaust air connection directed toward the rear or the side is arranged in the lower section of the dryer. In one embodiment of the dryer a recirculation part is interposed between the heating unit and the exhaust air connection, via which part of the process air can be fed back to the laundry to be dried as circulating air, and with which a relationship between the exhaust air and circulating air can be varied.

EP 0 702 105 B1 describes a housing for a fan in a household appliance, in particular in a household laundry dryer which enables a reduction in the noise arising and a damping of such noise as does arise. The housing has a radial fan wheel, which is built in to a spiral housing in a rotatable manner and to which the air is fed in an axial manner, the spiral housing being surrounded in a dividable manner by a wall element of the housing with the wall-like structure of a jacket shaped to match the spiral contour and at a distance from it, and means for maintaining the spacing being provided.

### SUMMARY OF THE INVENTION

An object of an exemplary embodiment of the present invention is thus to provide a dryer, in particular an exhaust air dryer, which is less prone to soiling with fluff (clogging). In this dryer, a fan used therein to convey the process air dryer should preferably be less prone to clogging.

An exemplary embodiment of the invention thus relates to an exhaust air dryer with a drum for drying damp laundry by means of warm process air, a heating device to heat the process air in a first process air channel upstream of the drum, into which a supply air channel and a first end of a circulating air channel lead, a second process air channel downstream of the drum, into which an exhaust air channel and a second end of the circulating air channel lead, and a fan containing an impeller with a blade configuration, the impeller having blades which are straight and/or curved backwards in the direction of movement toward the drum.

Depending on the embodiment and its spatial and functional characteristics, the fan can be located upstream or downstream of the drum.

In an exemplary embodiment of the inventive exhaust air dryer, the impeller has blades curved backwards in the direction of movement. In an exemplary embodiment, the impeller has exclusively blades which are curved backwards in the direction of movement.

The impeller and the blades it contains can be made up of a very wide variety of materials, such as metal or plastic. The impeller may be made of plastic. This enables efficient manufacture, for example using injection molding techniques.

According to an exemplary embodiment of the invention the blade configuration of the impeller can be straight or inclined. An inclined blade configuration is preferably employed. An “inclined” blade configuration within the meaning of the invention means that the blades of the impeller form an angle unequal to 90° with the circumference of the impeller. In the case of a “straight” blade configuration, an angle of 90° would be described. Consequently, “inclined” means that the edge of a blade lies other than parallel to the rotational axis of the impeller during operation of the fan, and the blades are curved around the axis of rotation in a screw-like manner. It is also conceivable to embody the blades in a more or less curved manner, thus combining the features of radial and curved blades. On an internal face of the impeller a curved blade can for example be aligned in inclined form relative to a radial and on an external face of the impeller extend in a more or less radial direction—this would be a so-called “radial-ended blade configuration.”

The surprising discovery was made that an impeller with an inclined blade configuration leads to a marked reduction in noise compared with an impeller with a straight blade configuration, but otherwise identical. This applies particularly in the case of minimal distances between the blades of the impeller and the tongue of the fan housing, as acoustic notes can particularly readily be heard and measured in this instance. However the realization of small distances between tongue and blade or impeller respectively is an important means of enhancing the performance of a transverse flow fan, due to the generally restricted structural space in fans which are to be minimized in size.

In an exemplary embodiment of the inventive exhaust air dryer, the tendency toward clogging of the air passages and in particular of the fan is significantly reduced. Within the framework of an exemplary embodiment of the invention, the fluff content in the process air can be reduced by means of one or more suitable fluff filters or fluff traps. The terms “fluff filter” and “fluff trap” are here to be broadly interpreted. This also includes, for example, a heat exchanger (condenser), in which the humid air coming from the dryer, which is additionally laden with fluff, is cooled through heat exchange with a suitable cooling medium (supply air or cool air in an air-air-heat exchanger; coolant in the evaporator of a heat pump), and the moisture contained in the process air condensed out. Fluff can adhere to and remain lodged on the thus wet condenser; it can therefore function as a kind of fluff filter. In addition, netting of different mesh sizes can also be employed as a fluff filter.

According to an exemplary embodiment of the invention it has also proved to be particularly advantageous if the exhaust air dryer has a fluff trap in the circulating air channel. It is even more advantageous if the fluff filter takes the form of a labyrinth. In such a labyrinth the fluff-bearing air is conveyed in such a way as to bring about the formation of a vortex and the separating-out of fluff. The labyrinth is preferably capable of functioning throughout the operating lifetime of the exhaust air dryer without the need for interim cleaning.

An exemplary embodiment of the inventive dryer and the fan contained within it may include sound-damping components, as, for example, described in EP 0 702 105 B1. The further sound-damping measures likewise described in EP 0 702 105 B1 can additionally be adopted. Examples of this are double-walled construction of the spiral housing of the fan and minimizing of the number of acoustic bridges, perforation of the spiral jacket and the filling of intermediate spaces with insulation material.

An exemplary embodiment of the inventive exhaust air dryer can be operated with or without a heat exchanger for condensation of the moisture contained in the warm process air after its passage through the drum.

The subject matter of an exemplary embodiment of the invention is additionally a method for operation of an exhaust air dryer, with a drum for drying damp laundry by means of warm process air, a heating device for heating the process air in a first process air channel upstream of the drum, into which a supply air channel and a first end of a circulating air channel discharge, a second process air channel downstream of the drum, into which an exhaust air channel and a second end of the circulating air channel discharge, and a fan, having an impeller with a blade configuration, wherein the impeller has fan blades which are straight and/or curved backwards in the direction of movement toward the drum, wherein the process air laden with fluff and emerging from the drum in the second process air channel is partly directed into the exhaust air channel and partly into the circulating air channel.

In the case of the impeller used in the inventive exhaust air dryer, the number of individual blades may vary within a wide range. The impeller is generally built into the fan in a rotatable manner, in a spiral housing, the air being fed to the impeller in an axial manner.

An exemplary embodiment of the inventive exhaust air dryer has the advantage that when carrying out a method, the components of the exhaust air dryer, in particular its air passages and its fan are markedly less susceptible to soiling. This advantage is particularly evident in the case of exhaust air dryers with a circulating air section, having no heat exchanger for the condensing of moisture contained in the warm process air.

It is furthermore advantageous in the case of an exemplary embodiment of the inventive exhaust air dryer with a fan with a slant-bladed impeller (“impeller with inclined blade configuration”) that an impeller with a greater diameter can be employed than is the case with a straight-bladed impeller, without the noise level increasing. Higher fan output can thereby be realized without incurring higher levels of noise.

### BRIEF DESCRIPTION OF THE DRAWINGS

The present invention will now be described in greater detail on the basis of non-restrictive exemplary embodiments. Reference is made to FIGS. 1 to 3.

FIG. 1 shows a partial cutaway view of an exhaust air dryer;

FIG. 2 shows an impeller with a backward-curved blade configuration as used in an exhaust air dryer, viewed from an angle; and

FIG. 3 show the same impeller in cross section.

### DETAILED DESCRIPTION OF EXEMPLARY EMBODIMENTS OF THE INVENTION

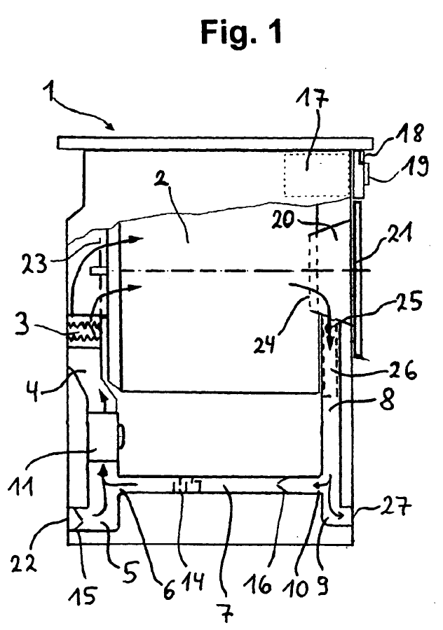

FIG. 1 shows a partial cutaway view of an exhaust air dryer 1. In its upper section, this has a programmed control 17, which can be set by means of a manual operating mechanism 19, and can preferably contain a fuzzy-processor controller (not shown here). 18 indicates a display device for indicating various statuses of the exhaust air dryer 1.

The exhaust air dryer 1 has a drum 2, which is accessible from outside by means of an opening 20 of a loading door 21, and via which items of laundry to be dried can be placed in the drum 2 and removed from the same.

Embodied at the rear of the laundry dryer 1 is a process air aperture 22, into which air is ingested from outside via a fan 11 and guided into a first process air channel 4. From the process air channel 4, the fresh process air (also designated “supply air”) passes further, via a heating device 3, to the entrance 23 of the drum 2. The process air traverses the drum 2 and flows to the outlet 24 through a second process air channel 8. In the second process air channel 8 behind the drum 2 is arranged a temperature sensor 25, which at predefined intervals records the temperature of the process air, and supplies the measured value to the programmed control device 17.

In the second process air channel 8 a fluff filter 26 is located. The process air flows through the second process air channel 8, which is split into a circulating air channel 7 and an exhaust air channel 9. Via the exhaust air channel 9 a portion of the process air from the drum 2 thus reaches an exhaust air outlet 27, whence the process air flows into the room in which the exhaust air dryer is set up, as exhaust air. The remaining part of the process air flows through the circulating air channel 7, in which is arranged a labyrinth 14 serving as a fluff trap 14, via the fan 11 and the heating device 3 back into the drum 2. The exhaust air dryer 1 of this embodiment thus works according to the exhaust air principle with a circulating air section. In the embodiment of the exhaust air dryer shown in FIG. 1, the relative proportions of supply air and circulating air can be set via a first valve or flap 15 in the supply air channel 5 and a second valve or flap 16 in the circulating air channel 7.

In the embodiment shown here, the fan 11 is arranged upstream of the drum 2 relative to the direction of the airflow, that is in the first process air channel 4. It would likewise be conceivable and possible to arrange the fan 11 in the second process air channel 8 and thus downstream of the drum 2 relative to the direction of the airflow.

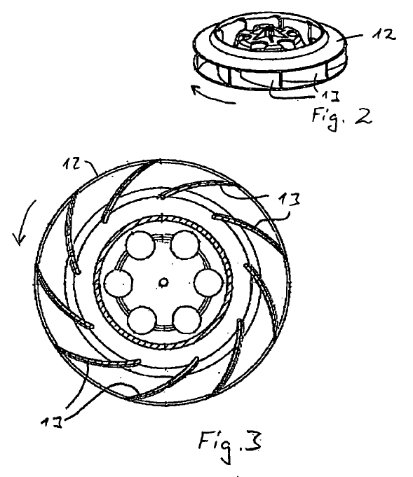

FIG. 2 shows an oblique view of an impeller 12 employed in the fan 11 of the exhaust air dryer with a backward-curved blade configuration 13. FIG. 3 shows a cross-section through the same impeller 12 with inclined blade configuration 13. In the FIGS. 2 and 3, the arrows show the direction of movement of the impeller 12 in the fan 11.

1. An exhaust air dryer comprising:
a drum for drying damp laundry by means of warm process air;
a first process air channel upstream of the drum;
a heater that heats process air in the first process air channel;
a supply air channel discharging into the first process air channel;
a circulating air channel having a first end discharging into the first process air channel;
a second process air channel downstream of the drum, the second process air channel discharging into a second end of the circulating air channel and an exhaust air channel; and
a fan having an impeller with fan blades that are straight and/or curved backwards in a direction of movement toward the drum.

2. The exhaust air dryer of claim 1, wherein the fan blades are curved backwards in the direction of movement.

4. The exhaust air dryer of claim 1, wherein the impeller comprises plastic.

5. The exhaust air dryer of claim 1, wherein the fan blades are straight.

6. The exhaust air dryer of claim 1, wherein the impeller has an inclined blade configuration.

7. The exhaust air dryer of claim 1, further comprising a fluff trap in the circulating air channel.

8. The exhaust air dryer of claim 7, wherein the fluff trap comprises a labyrinth.

9. A method for operating an exhaust air dryer, the method comprising:
heating a process air in a first process air channel upstream of a drum,
discharging from a supply air channel and a first end of a circulating air channel into the first process air channel;
discharging a first portion of fluff laden air from a second process air channel downstream of the drum into an exhaust air channel and a second portion of fluff leaden air into a second end of the circulating air channel discharge; and
providing a fan an impeller with blades which are straight and/or curved backwards in the direction of movement toward the drum.
